(19) United States
(12) Patent Application Publication
(10) Pub. No.: US 2015/0149410 A1
(43) Pub. Date: May 28, 2015

(54) PUBLISHING TO A CONTENT DELIVERY SYSTEM

(71) Applicant: Microsoft Corporation, Redmond, WA (US)

(72) Inventors: ANDREW C. HAON, SEATTLE, WA (US); SOHAIL TARIQ, REDMOND, WA (US); ROU-PENG HUANG, WOODINVILLE, WA (US); LUCIANA SILVA DANTAS, SAMMAMISH, WA (US); LAUREN ELIZABETH ANN JAVOR, SEATTLE, WA (US); DANIEL J. RONEY, SEATTLE, WA (US); RAMKUMAR KRISHNAN, REDMOND, WA (US); MARK ALLAN HOPWOOD, KIRKLAND, WA (US); ULZIIDELGER LOBO, SAMMAMISH, WA (US)

(73) Assignee: Microsoft Corporation, Redmond, WA (US)

(21) Appl. No.: 14/091,408

(22) Filed: Nov. 27, 2013

(51) Int. Cl. G06F 17/30

(52) U.S. Cl. CPC G06F 17/30038
USPC 707/627

(57) ABSTRACT

Publishing a document from a cloud storage and/or productivity application is described. A cloud storage and/or productivity application can include a command to publish that may be executed from a user interface to the cloud storage and/or productivity application. In response to receiving a request to publish the document through a user interface, a copy of a document to be published can be communicated to a publish service of a content delivery system. The copy of the document can be a productivity application file.

### BACKGROUND

Online services such as those provided by cloud storage providers are gaining in popularity. The cloud storage providers can manage services with respect to a shared document repository, or “cloud storage”. For example, cloud storage providers, through internet-based storage services, can synchronize and back-up files, and enable account holders to access their files from multiple devices, locations, and even operating systems.

Currently, there are many options to sharing a document or other content with others. For files in cloud storage, the files can be made accessible to others, for example by obtaining a copy of the document or a uniform resource locator (URL) to the file location. Typically, to obtain a URL to a file stored with a cloud storage provider, a user navigates to the cloud storage provider portal in a web browser, adjusts permissions (if needed) on a document or file, and obtains the URL. The permissions are granted by the account holder to enable others to access, view and/or edit such files. To inform others of the file, an account holder would share a URL to the file. This may entail emailing or otherwise messaging the URL to each individual or group to enable them to access the document stored by the cloud storage provider. In some cases, documents or files could be shared via posting a URL to the file on a social media site such as FACEBOOK.

### BRIEF SUMMARY

Publishing a document from a cloud storage and/or productivity application is described. A command from a user interface to the cloud storage and/or productivity application can invoke a publish service. Instead of a link to a document, a copy of the document can be communicated to the publish service so that the document may be made available to the public. In some scenarios, the copy of the document can be provided in a word processing document file format, presentation file format, spreadsheet file format, or other productivity application file format.

A method to facilitate the publishing of a document to a content delivery system can include communicating a copy of the document to a publish service in response to receiving a request to publish the document through a user interface of a cloud storage provider. The document may be stored in the shared document repository managed by the cloud storage provider. The publish service can receive the copy of the document along with metadata such as author identity. The author identity may be automatically populated with a user identifier of the person signed in to the cloud storage account. Additional metadata may be included through the interface to the cloud storage.

Publishing to a content delivery system can also be accomplished through a user interface of a productivity application such that a command in the user interface invokes the publish service. Similar to the cloud storage scenario, a copy of the document can be provided to the publish service.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an operating environment in which publishing to a content delivery system may be carried out.

FIG. 2 illustrates a method of facilitating document collections distribution and publishing.

FIG. 3 illustrates a diagram with example process flows.

FIG. 4 illustrates an example user interface for publishing content through a cloud storage service.

FIGS. 5A and 5B illustrate example user interfaces for publishing content through productivity applications.

FIG. 6 shows a block diagram illustrating components of a computing device used in some embodiments.

FIG. 7 shows a block diagram illustrating example details of a server computing system used in some embodiments.

FIG. 8 illustrates example system architectures in which embodiments may be carried out.

### DETAILED DESCRIPTION

Techniques and systems for publishing documents are described. According to various implementations, a user may publish a document to a content delivery system directly from cloud storage or a productivity application.

A content delivery system refers to a platform that may present documents for public consumption. Examples of a content delivery system include SCRIBD from Scribd Inc. and DOCSTOC from Docstoc Inc.

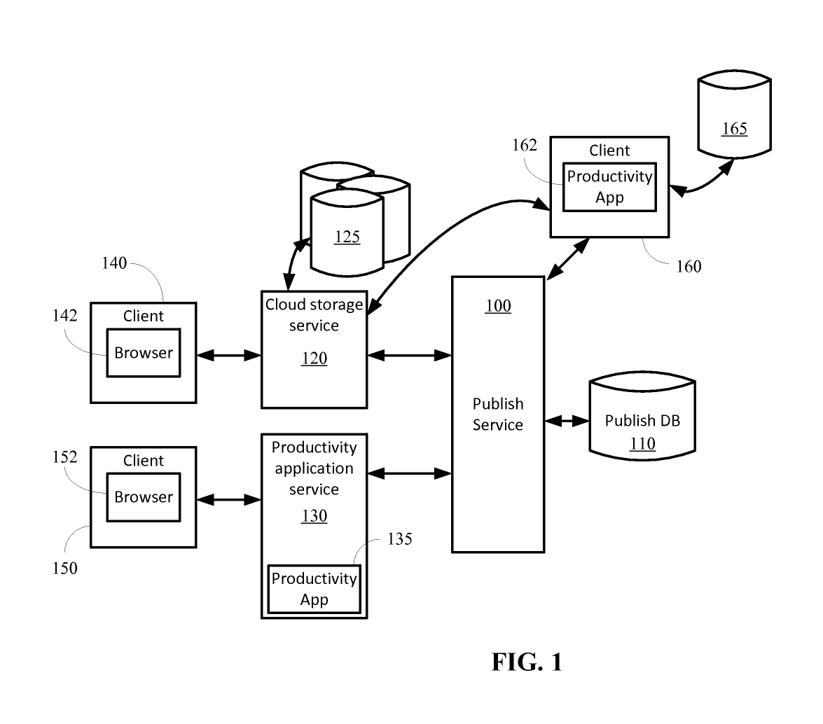

FIG. 1 illustrates an operating environment in which publishing to a content delivery system may be carried out. Referring to FIG. 1, a publish service 100 may be provided that can facilitate the publishing and discovery of documents on the Web. The publish service 100 facilitates the storage of a user's content for access by the public that may be interested in the content. Distribution networks can provide a platform for publishing the content. The publish service 100 described herein can be characterized in that it includes and/or manages a documents database 110 as part of a content delivery system. The documents database 110 may be one or more databases managed or used by the publish service 100. By being published via the service, the document can be discoverable, read and otherwise available to the public for consumption.

The publish service 100 can include an application programming interface (API) that enables publishing to the service via a document repository or productivity application. An API is generally a set of programming instructions and standards for enabling two or more applications to communicate with each other and is commonly implemented as a set of Hypertext Transfer Protocol (HTTP) request messages and a specified format or structure for response messages according to a REST (Representational state transfer) or SOAP (Simple Object Access Protocol) architecture. The messages can contain an information resource. A resource is information that can be identified by a uniform resource identifier (URI) and may be a file, a dynamically-generated query result, the output of a common gateway interface (CGI) script, a document that is available in several languages, and the like. Common formats for the messages include Extensible Markup Language (XML) and JavaScript Object Notation (JSON) formats.

The publishing environment can further include a cloud storage service 120 and/or a productivity application service 130 that communicate with the publish service 100 via ubiquitous Web protocols and data formats such as HTTP, XML, JSON and SOAP.

The cloud storage service 120 is representative of any software service, application, module, or collections thereof, in which access to cloud storage 125 may be accomplished.

“Cloud storage” is a type of networked storage where data is stored in virtualized pools of storage, spanning across multiple servers and multiple locations. These networked storage pools are often operated by companies with large data centers, such as Amazon.com Inc. or Google Inc. End users and companies may then lease storage capacity from them. The purchasers of these storage pools connect to them using the internet or, less frequently, over private networks.

“Cloud storage services” are generally provided to enhance the ease of interaction with cloud storage. Cloud storage services include MICROSOFT SKYDRIVE, GOOGLE DRIVE, BOX, and DROPBOX file hosting services. The consumer interaction can be through applications on various computing platforms such as desktop computers, tablets, and smartphones. An application is often installed on the local device to integrate with the remote cloud storage devices to explore, upload, and synchronize files. These services also typically have a web browser interface to the stored files which allows the user control them when the provider's interface application is not installed on the local device.

The productivity application service 130 is representative of any software service, application, module, or collections thereof, in which a productivity application 135 may be employed to facilitate creation, modification, and interaction of content.

A productivity application refers to software directed to accomplishing tasks related to producing content. Examples of productivity applications include the MICROSOFT OFFICE suite of applications from Microsoft Corp., including MICROSOFT WORD, MICROSOFT EXCEL, MICROSOFT POWERPOINT, all registered trademarks of Microsoft Corp.; the APACHE OPENOFFICE available from the Apache Software Foundation; the LIBREOFFICE suite of applications available from THE DOCUMENT FOUNDATION, registered trademarks of The Document Foundation; and the APPLE iWORK suite of applications from Apple Inc, including APPLE PAGES, APPLE KEYNOTE, and APPLE NUMBERS, all registered trademarks of Apple Inc.

In some cases, the cloud storage service and the productivity application service are integrated, for example in a manner similar to GOOGLE DOCS or even MICROSOFT OFFICE 365 and SKYDRIVE.

The service architecture of the cloud storage service 120 and/or the productivity application service 130 can include databases, software components, extended markup language schemas and any shared directories. Certain agents may be employed by the cloud storage service and/or the productivity application service to perform certain tasks with respect to data being communicated between end points.

Cloud computing architecture generally involves a front end platform (e.g., client, mobile device), a back end platform (e.g., servers, storage systems), a cloud-based delivery, and a network (e.g., the Internet). The clients of the front end platform interact with the storage systems of the back end platform via an application, web browser, or through a virtual layer.

Various types of physical or virtual computing systems may be used to implement any and each of the publish service 100, the cloud storage service 120, and the productivity application service 130, such as server computers, desktop computers, laptop computers, tablet computers, smart phones, or any other suitable computing appliance, of which computing system 700, discussed below with respect to FIG. 7, is representative. When implemented using a sever computer, any of a variety of servers may be used including, but not limited to, application servers, database servers, mail servers, rack servers, blade servers, tower servers, or any other type server, variation of server, or combination thereof.

Multiple clients may interact with the services over a network. The network can include, but is not limited to, a cellular network (e.g., wireless phone), a point-to-point dial up connection, a satellite network, the Internet, a local area network (LAN), a wide area network (WAN), a WiFi network, an ad hoc network or a combination thereof. Such networks are widely used to connect various types of network elements, such as hubs, bridges, routers, switches, servers, and gateways. The network may include one or more connected networks (e.g., a multi-network environment) including public networks, such as the Internet, and/or private networks such as a secure enterprise private network. Access to the network may be provided via one or more wired or wireless access networks as will be understood by those skilled in the art.

In one scenario, a user desiring to publish a document while on a first client device 140 may be accessing the cloud storage service 120 through a user interface to the cloud storage service 120 that is rendered in a browser 142 of the first client device 140. The browser 142 may be a web browser or a mobile browser. Based on a command received by the cloud storage service 120 via the user interface, the cloud storage service 120 can then communicate with the publish service 100 to publish a document that is stored in the cloud storage 125.

In another scenario, a user desiring to publish a document while on a second client device 150 may be accessing the productivity application service 130 through a user interface to the productivity application service 150 that is rendered in a browser 152 of the second client device 150. The browser 152 may be a web browser or a mobile browser. The Based on a command received by the productivity application service 130 via the user interface, the productivity application service 130 can then communicate with the publish service 100 to publish the document. The document may be a document temporarily or intentionally stored locally at the client 150, at a storage associated with the productivity application service 130, or even at the cloud storage 125.

In yet another scenario, a user desiring to publish a document while on a third client device 160 may do so while working within a local productivity application 162. Then, based on a command received by a user interface of the local productivity application 162, the local productivity application 162 can communicate with the publish service 100 to publish a document stored in a storage 165 associated with the client device 160 (e.g., a local drive or a storage connected to the client device via an intranet or other network) or a document stored in cloud storage 125 (and accessed via the cloud storage service 120).

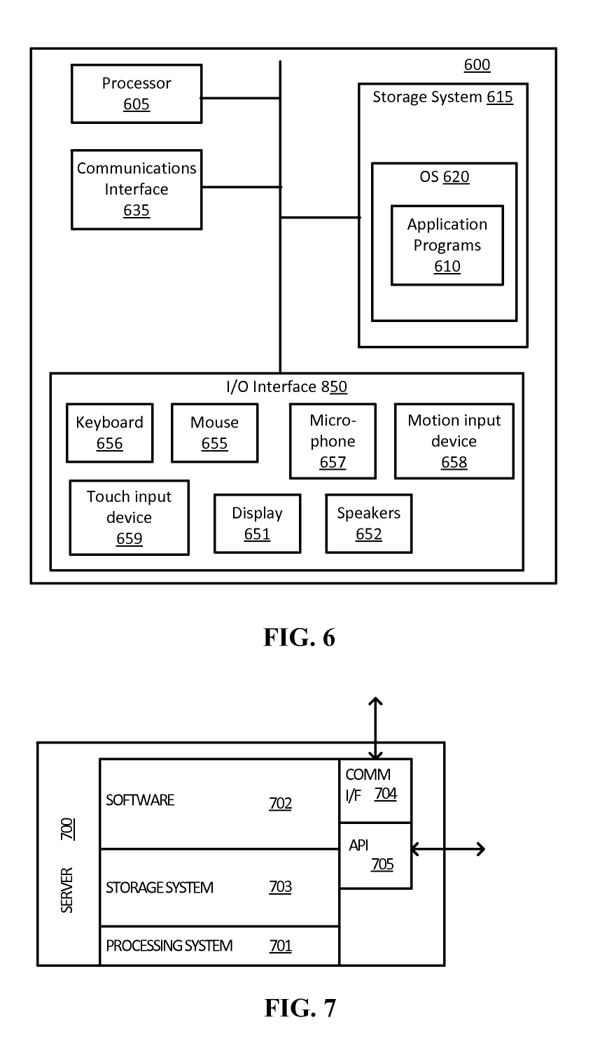

Various types of physical or virtual computing systems may be used to implement the client devices 140, 150, and 160, such as server computers, desktop computers, laptop computers, tablet computers, smart phones, wearable computers (e.g., watches and glasses), gaming appliances, or any other suitable computing appliance, of which computing system 600, discussed below with respect to FIG. 6, may be representative. A user may interact with any of the described user interfaces to cloud storage and productivity applications via voice, touch, pointer device (e.g., mouse), non-contact gestures, and keyboard/keypad as non-limiting examples.

The publish service 100 can receive and publish documents of any format, including MICROSOFT OFFICE productivity application file type formats. Embodiments enable the sharing (distribution and publishing) of documents that are in an Office Open Extensible Markup Language (XML) file format (.docx, .pptx, .xlsx), MICROSOFT WORD document file format (.doc) or other word processing document file format, MICROSOFT EXCEL binary file format (.xls) or other spreadsheet file format, MICROSOFT POWERPOINT presentation file format (.ppt) or other presentation file format.

Accordingly, a copy of the document being published can remain in the format to which it was created and be published directly from cloud storage 125 (via a cloud storage service 120) or a productivity application (e.g., via a productivity application service 130 or local productivity application 162).

The cloud storage service and the productivity application (and service) do not need to be able to convert the document file format to HTML or other file type in order to enable a document to be published. Instead, a call to the publish service and a message sending a copy of the document is sufficient to enable the document to be published. The publish service then stores the copy of the document and makes the document available to the public. The publish service can manage metadata associated with the document to facilitate classification, search, and attribution. The document can be attributed to the user submitting the document by associated metadata with the document. The attribution may be based on author metadata provided to the publish service. The author metadata may be automatically generated by the cloud storage or productivity application (for example, because a user may be signed in and authenticated to use one or both of the services).

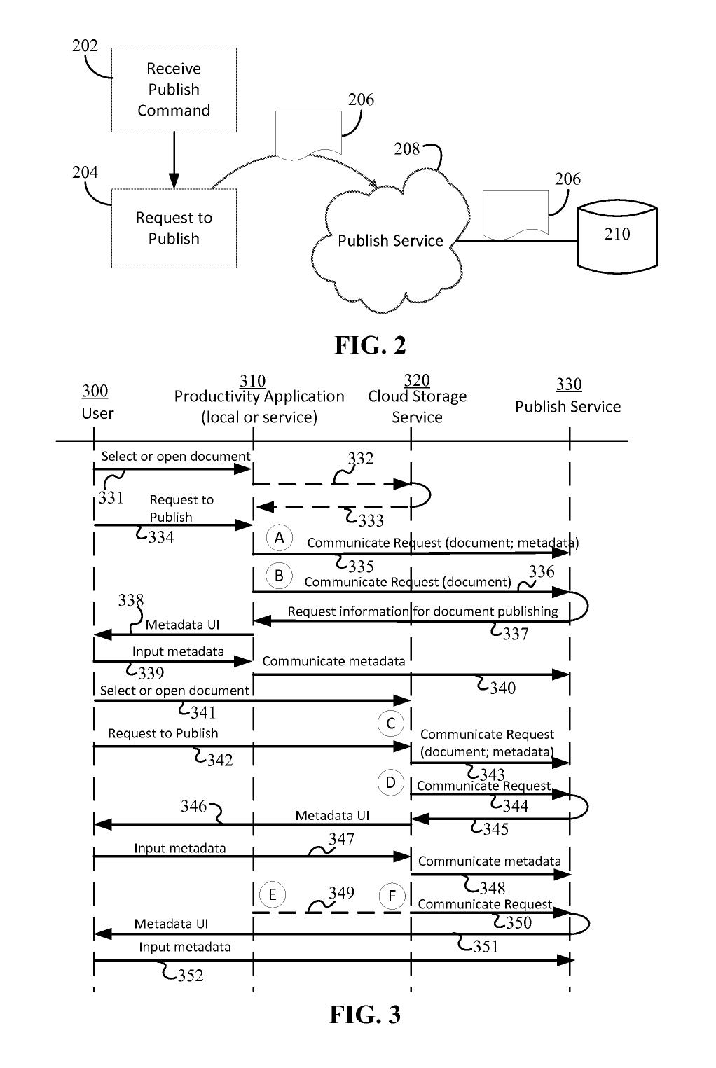

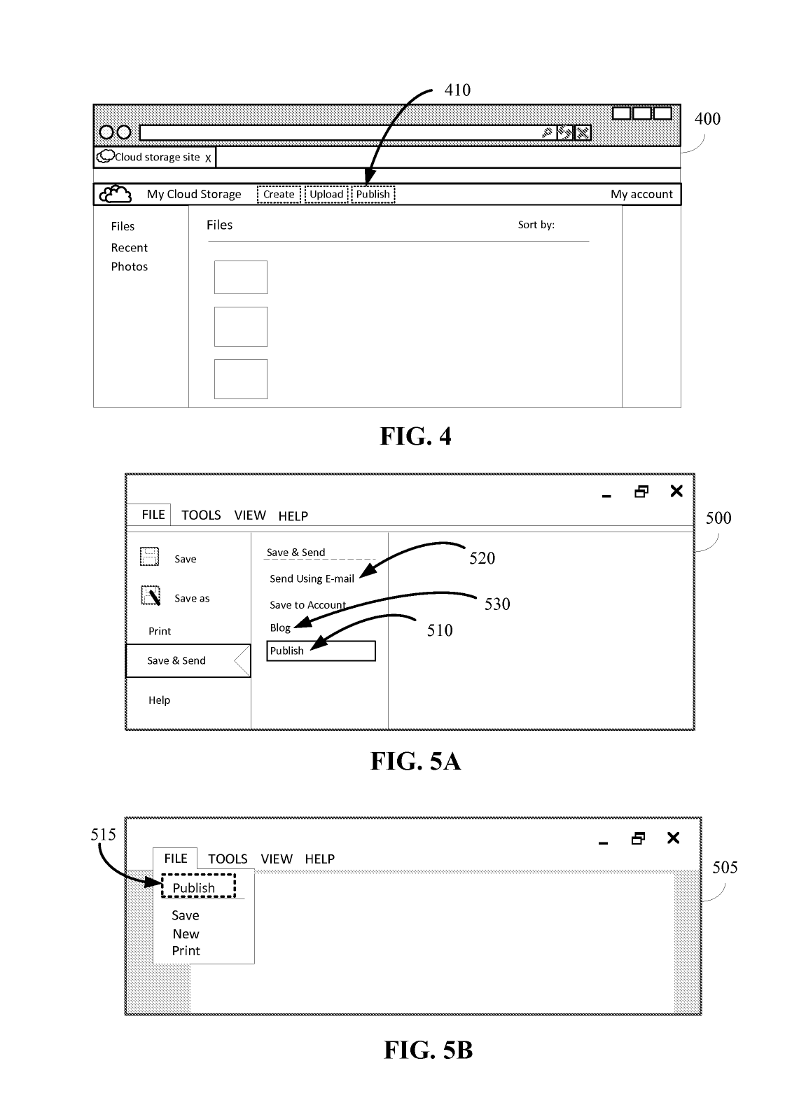

FIG. 2 shows a diagram of a process carried out by a cloud storage application or a productivity application. FIG. 3 illustrates a diagram with example process flows. FIG. 4 illustrates an example user interface for publishing content through a cloud storage service. FIGS. 5A and 5B illustrate example user interfaces for publishing content through productivity applications. FIG. 5A shows a representative desktop productivity application interface; FIG. 5B shows a representative online productivity application interface that may be associated with a cloud storage provider (for example as a productivity application page of a file storage and synchronization service).

Referring to FIG. 2, at operation (202), a command to publish can be received by the application through a user interface of the application. In response to receiving the command to publish, the application can request publication (204) of a document indicated by the publish command as the document 206 to be published. The request to publish can be carried out by invoking a publish service 208 and sending a copy of the document 206 to the publish service 208. The publish service 208 can store the copy of the document 206 in the database 210 in order to publish the document.

Some example scenarios are illustrated in FIG. 3. Referring to FIG. 3, a user 300 may interact with a productivity application 310 and/or cloud storage service 320 in order to publish a document via a publish service 330 of a content delivery system. Initially, a user may select or open (331) a document in a productivity application 310. Other interactions may take place between the user 300 and the productivity application 310, for example interactions to create or modify a document. The document may be stored locally or at a cloud storage. For cases where the document is stored in a cloud storage, the productivity application 310 may communicate (332) with a cloud storage service (320) to retrieve (333) the document (or render the document for viewing).

When the user 300 desires to publish the document, the user 300 can do so directly from the productivity application 310 by requesting publication (334) via the user interface of the productivity application 310. In case A, the productivity application 310, in response to receiving the command to publish (334) from the user 300, can communicate (335) the request along with a copy of the document and metadata to the publish service 330. In case B, the productivity application 310 and the publish service 330 can communicate at least a first time (336) to indicate that a document is to be published and be informed (337) of the information that the publish service is to receive. The information for the publish service can be presented to the user 300 in a metadata user interface (UI) (338). This UI may be presented as part of the productivity application or in a separate window. The user 300 may then input information (339) such as title and tags so that the productivity application can communicate (340) the metadata to the publish service 330.

Similar to the case with the productivity application 310, a user 300 may select or open (341) a document in a cloud storage application/service 320. Other interactions may take place between the user 300 and the cloud storage service 320, for example interactions to organize files and adjust permissions of a document (or folder).

When the user 300 desires to publish the document, the user 300 can do so directly from the cloud storage service 320 by requesting publication (342) via the user interface of the cloud storage service 320. In case C, the cloud storage service 320, in response to receiving the command to publish (342) from the user 300, can communicate (343) the request along with a copy of the document and metadata to the publish service 330. In case D, the cloud storage service 310 and the publish service 330 can communicate at least a first time (344) to indicate that a document is to be published and be informed (345) of the information that the publish service is to receive. The information for the publish service can be presented to the user 300 in a metadata user interface (UI) (346). This UI may be presented as part of the cloud storage application or in a separate window. The user 300 may then input information (347) such as title and tags so that the cloud storage service may communicate (348) the metadata to the publish service 330.

In some cases, as illustrated in cases E and F, once the productivity application (case E) or the cloud storage service (case F) communicates the request (350) to publish to the publish service 330, The user may interact more directly with the publish service, for example, in the form of a metadata UI (351) that is presented to the user upon the user navigating to a site associated with the content delivery system or as a UI that is launched in a browser of the user's device separate from the productivity application and/or cloud storage service. The user may input information (352) via the metadata UI to the publish service 330, bypassing additional communications between the productivity application 310 and/or cloud storage service 320.

Through invoking a publication service, productivity applications and applications for managing a user's account in a shared document repository (e.g., cloud storage provider applications) can enable a user to publish a document. Furthermore, the publish service can receive the document without converting the document to a different format.

As illustrated in FIG. 4, a command from a cloud storage provider interface 400 can call the publish service and send a copy of the document along with metadata associated with the document (such as title, author, date). Embodiments facilitate publishing the file in a manner that makes the file discoverable by the public without express sharing of the files in their account. An option is provided from a cloud storage provider interface to send the file to a publish service that retains a copy of the file, not a link to the file.

For example, a menu command 410 can be provided such that selection of the command 410 invokes the service. A window may open that enables the inclusion of certain information (e.g., user selected metadata for the document) with the document. The metadata may include a cover image or text for the document when displayed by the publish service and tags for the document to facilitate the surfacing of the document in a search as well as classification of the document within the publication service.

As illustrated in FIGS. 5A and 5B, this command can also be available in a menu of a productivity application (and even combination productivity and cloud storage applications such as provided by Google as GOOGLE DRIVE). Referring to FIGS. 5A and 5B, a productivity application interface 500, 505 can include sharing options such as a publish command 510, 515, which causes the productivity application to invoke the publish service.

In addition to publishing a document, the productivity applications may further enable the sharing of documents while within the application by communicating with other services and applications providing the sharing functionality. For example, as illustrated in FIG. 5A, a word processing application such as MICROSOFT WORD includes an option to share a copy of the document via email (e.g., 520), which enables a copy of the document to be attached to an email; an option to share the document with specific recipients; and an option to share the document by converting to HTML and posting on a blog (e.g., 530).

FIG. 6 shows a block diagram illustrating components of a computing device used in some embodiments. System 600 may be implemented within a single computing device or distributed across multiple computing devices or sub-systems that cooperate in executing program instructions. System 600 can be used to implement myriad computing devices, including but not limited to a personal computer, a tablet computer, a reader, a mobile device, a personal digital assistant, a smartphone, a laptop computer (notebook or netbook), a gaming device or console, a desktop computer, or a smart television. Accordingly, more or less elements described with respect to system 600 may be incorporated to implement a particular computing device.

It should be understood that computing system 600 is generally intended to represent a computing system with which software is deployed and executed in order to implement a cloud storage application or productivity application as described herein. However, computing system 600 may also represent any computing system on which software may be staged and from where software may be distributed, transported, downloaded, or otherwise provided to yet another computing system for deployment and execution, or yet additional distribution.

System 600, for example, includes a processor 605 which processes data according to the instructions of one or more application programs 610 interacting with the device operating system (OS) 620. Examples of processors for the processor 605 include general purpose central processing units, application specific processors, and logic devices, as well as any other type of processing device, combinations, or variations thereof.

The application programs 610, operating system (OS) 620 and other software may be loaded into and stored in a storage system 615. Device operating systems 620 generally control and coordinate the functions of the various components in the computing device, providing an easier way for applications to connect with lower level interfaces like the networking interface. Non-limiting examples of operating systems include WINDOWS from Microsoft Corp., IOS from Apple, Inc., ANDROID OS from Google, Inc., WINDOWS RT from Microsoft, and the Ubuntu variety of the Linux OS from Canonical.

It should be noted that the OS 620 may be implemented both natively on the computing device and on software virtualization layers running atop the native Device OS. Virtualized OS layers, while not depicted in FIG. 6, can be thought of as additional, nested groupings within the OS 620 space, each containing an OS, application programs, and APIs.

Storage system 615 may comprise any computer readable storage media readable by the processor 605 and capable of storing software (e.g., application programs 610 and OS 620).

Storage system 615 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, DVDs, CDs, virtual memory and non-virtual memory, magnetic cassettes, magnetic tape, magnetic disk storage or other magnetic storage devices, or any other suitable storage media. In no case is the storage media a propagated signal. In addition to storage media, in some implementations storage system 615 may also include communication media over which software may be communicated internally or externally. Storage system 615 may be implemented as a single storage device but may also be implemented across multiple storage devices or sub-systems co-located or distributed relative to each other. Storage system 615 may comprise additional elements, such as a controller, capable of communicating with processor 605.

Software may be implemented in program instructions and among other functions may, when executed by system 600 in general or processor 605 in particular, direct system 600 or processor 605 to operate as described herein for the publishing of a document (e.g., as illustrated in FIG. 2). Software may include additional processes, programs, or components, such as operating system software or other application software. Software may also comprise firmware or some other form of machine-readable processing instructions executable by processor 605.

In general, software may, when loaded into processor 605 and executed, transform computing system 600 overall from a general-purpose computing system into a special-purpose computing system customized to facilitate publishing to a content delivery system as described herein. Indeed, encoding software on storage system 615 may transform the physical structure of storage system 615. The specific transformation of the physical structure may depend on various factors in different implementations of this description. Examples of such factors may include, but are not limited to the technology used to implement the storage media of storage system 615 and whether the computer-storage media are characterized as primary or secondary storage.

For example, if the computer-storage media are implemented as semiconductor-based memory, software may transform the physical state of the semiconductor memory when the program is encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

Documents being published through the methods described herein may originally be stored on a user's computing device (in the storage system 615) or on any number of remote storage platforms that may be accessed by the user's computing device over communication networks via the communications interface 635. Such remote storage providers might include, for example, a server computer in a distributed computing network, such as the Internet. They may also include “cloud storage providers” whose data and functionality are accessible to applications through OS functions or APIs.

Communications interface 635 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS 620, which informs applications and APIs of communications events when necessary.

Various elements of system 600 may be included in a system-on-a-chip (SoC) device. These elements may include processor(s), communications interface 635 and elements of the storage system 615.

Input/Output (I/O) interface 650 may include input devices such as a mouse 655, track pad, keyboard 656, microphone 657, a touch device 659 for receiving a touch gesture from a user, a motion input device 658 for detecting non-touch gestures and other motions by a user, and other types of input devices and their associated processing elements capable of receiving user input. I/O interface 650 ma also include output devices such as display screens 651, speakers 652, haptic devices for tactile feedback, and other types of output devices may be included in user interface 650. In certain cases, the input and output devices may be combined in a single device, such as a touchscreen display which both depicts images and receives touch gesture input from the user. Visual output may be depicted on the display 651 in myriad ways, presenting graphical user interface elements, text, images, video, notifications, virtual buttons, virtual keyboards, or any other type of information capable of being depicted in visual form. Other kinds of user interface are possible. I/O interface 650 may also include associated user interface software executed by the OS 620 in support of the various user input and output devices. Such software assists the OS in communicating user interface hardware events to application programs 610 using defined mechanisms.

FIG. 7 shows a block diagram illustrating example details of a server computing system used in some embodiments. The server computing system may be used to implement cloud storage and/or productivity application service(s). In some implementations, the server computing system may also be used to implement the publish service. The server 700 may include one or more computing devices. For example, the server 700 can include one or more blade server devices, standalone server devices, personal computers, routers, hubs, switches, bridges, firewall devices, intrusion detection devices, mainframe computers, network-attached storage devices, and other types of computing devices. The server hardware can be configured according to any suitable computer architectures such as a Symmetric Multi-Processing (SMP) architecture or a Non-Uniform Memory Access (NUMA) architecture.

The server 700 can include a processing system 701, which may include a processing device such as a central processing unit (CPU) or microprocessor and other circuitry that retrieves and executes software 702 from storage system 703. Processing system 701 may be implemented within a single processing device but may also be distributed across multiple processing devices or sub-systems that cooperate in executing program instructions.

Examples of processing system 701 include general purpose central processing units, application specific processors, and logic devices, as well as any other type of processing device, combinations, or variations thereof. The one or more processing devices may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain embodiments, one or more digital signal processors (DSPs) may be included as part of the computer hardware of the system in place of or in addition to a general purpose CPU.

Storage system 703 may comprise any computer readable storage media readable by processing system 701 and capable of storing software 702. Storage system 703 may be similar to storage system 615; therefore repeated discussion is not provided.

Server 700 may represent any computing system on which software 702 may be staged and from where software 702 may be distributed, transported, downloaded, or otherwise provided to yet another computing system for deployment and execution, or yet additional distribution.

In embodiments where the server 700 includes multiple computing devices, the server can include one or more communications networks that facilitate communication among the computing devices.

For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 704 may be included, providing communication connections and devices that allow for communication between server 700 and other computing systems (not shown) over a communication network or collection of networks (not shown) or the air. Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned communication media, network, connections, and devices are well known and need not be discussed at length here.

The server 700 also includes an API server 705. In various embodiments, the API server 705 can be implemented in various ways. For example, the API server 705 can be implemented as application software, utility software, or another type of software executed by one or more processing units of computing devices in the server system 700. Furthermore, in some embodiments, the API server 705 can be implemented using one or more application-specific integrated circuits (ASICs).

The API server 705 can be used to expose functionality available for the cloud storage, productivity application, and where server 700 also represents an implementation for the publish service, the API server 705 may be used to expose functionality available for the content delivery system of the publish service. The API server 705 may be a separate computing device from the server 700 or represent an API service of the server 700 that enables user devices or other servers to invoke methods in the API.

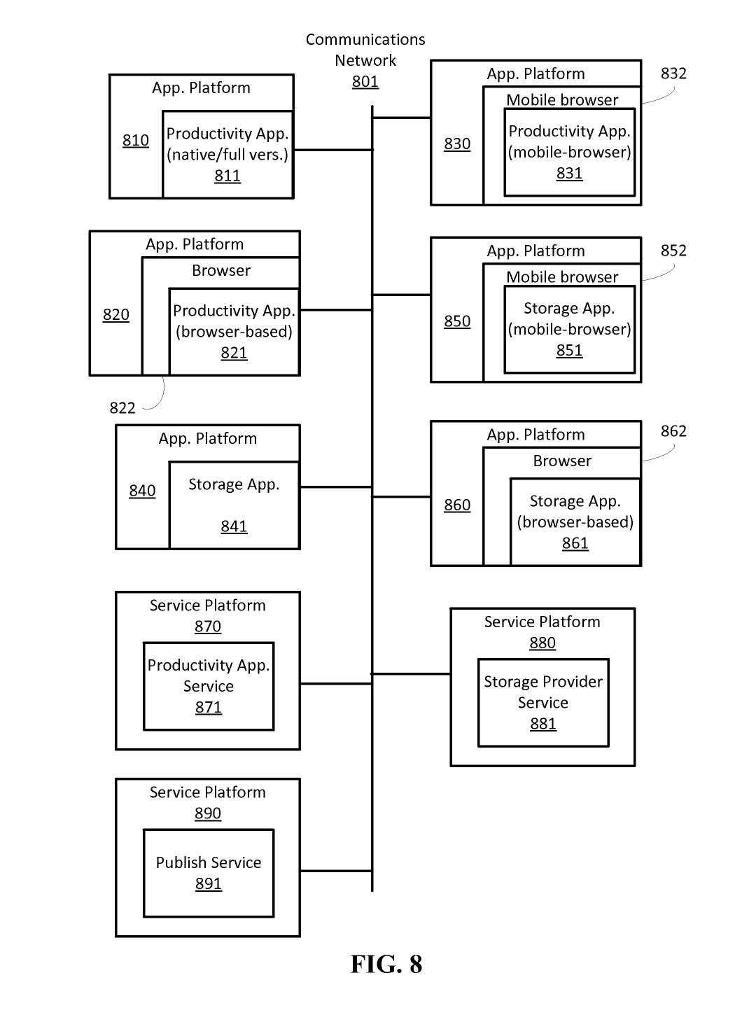

FIG. 8 illustrates an application environment 800 in which a document may be published. In particular, FIG. 8 shows various application platforms 810, 820, 830, 840, 850, and 860, each of which is capable of communicating with service platforms 870, 880, and 890 over communications network 801 to access storage devices, perform productivity tasks, and publish documents. The application platforms 810, 820, 830, 840, 850, and 860 may be any computing apparatus, device, system, or collection thereof employing a computing architecture suitable for implementing a productivity application (811, 821, 831) or a storage application for a cloud storage service (841, 851, 861) on that platform.

Productivity application 811 may be considered a full or “native” version that is locally installed and executed. In some cases, productivity application 811 may operate in a hybrid manner whereby a portion of the application is locally installed and executed and other portions are executed remotely and then streamed to application platform 810 for local rendering. Non-limiting examples of productivity application 811 include MICROSOFT OFFICE, LIBRE OFFICE, and iWORK.

Productivity application 821, implemented on application platform 820, may be considered a browser-based version that is executed wholly or partly in the context of a browser application 822. In this model, all or part of the programming instructions are executed remotely and the browser application 822 renders the result to the user's device through a visual expression language such as HTML. Non-limiting examples of productivity application 821 include MICROSOFT OFFICE 365 and GOOGLE DRIVE. Examples of the browser application 822 include GOOGLE CHROME, MICROSOFT INTERNET EXPLORER, and MOZILLA FIREFOX.

Productivity application 831 may be considered a mobile application version that is locally installed and executed on a mobile device. In some cases, Productivity application 831 may operate in a hybrid manner whereby a portion of the application is locally installed and executed and other portions are executed remotely and then streamed to application platform 830 for local rendering. Non-limiting examples of mobile productivity applications 831 include APPLE PAGES and APPLE NUMBERS.

Storage application 841, implemented on application platform 840, may be a desktop version of the software used with a cloud storage service. Non-limiting examples of storage application 841 include the software for MICROSOFT SKYDRIVE.

Storage application 851, implemented on application platform 850, may be considered a browser-based version that is executed wholly or partly in the context of a browser application 852. In this model, all or part of the programming instructions are executed remotely and the browser application 852 renders the result to the user's device through a visual expression language such as HTML. Non-limiting examples of storage application 851 include MICROSOFT SKYDRIVE, DROPBOX, and GOOGLE DRIVE. Examples of the browser application 852 include GOOGLE CHROME, MICROSOFT INTERNET EXPLORER, and MOZILLA FIREFOX.

Storage application 861, implemented on application platform 860, may be considered a mobile application version that is locally installed and executed on a mobile device. Non-limiting examples of mobile storage applications 861 include MICROSOFT SKYDRIVE and DROPBOX.

The application platforms 810, 820, 830, 840, 850, and 860 may communicate with service platforms 870, 880, and 890 connected by network 801. Service platforms may deliver a variety of services useful to the application platforms as well as enabling the publishing to the content delivery system.

For example, service platform 870 may deliver a productivity application service 871. Service 871 may host remote programming instructions and render their results to messaging applications or browsers on any of the application platforms, for example, productivity applications 821 and 831 on the application platforms 820 and 830.

Service platform 880 may deliver storage provider service 881, which enables non-local storage of files or other data which can be accessed and managed through storage applications 841, 851, and 861. Storage provider service 881 might be a cloud storage provider, a database server, or a local area network file server. Non-limiting examples of storage provider services include MICROSOFT SKYDRIVE, GOOGLE DRIVE, DROPBOX, BOX, and MICROSOFT SQL SERVER.

Service platform 890 may deliver a publish service 891 to which the documents sent by the storage service and/or productivity application/service are provided for publishing. The publish service stores the documents as part of a content delivery system that enables the discovery of documents by the public. The content delivery system may include or incorporate a web application component (WAC), for example in the form of an Office Web Application, that enables a user to at least view a document (e.g., in word processing document format, presentation document format, and spreadsheet document format), in a browser.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application.

What is claimed is:

1. A method of facilitating publishing to a content delivery system, comprising:
receiving a request to publish a document stored in a shared document repository of a cloud storage provider through a user interface to the cloud storage provider; and
in response to the request, communicating a copy of the document and metadata comprising at least an author of the document to a publish service.

2. The method of claim 1, wherein the copy of the document is a word processing document file, a presentation file, or a spreadsheet file.

3. The method of claim 1, wherein the copy of the document is an image file or portable document format file.

4. The method of claim 1, wherein the copy of the document comprises a same file type as the document stored in the shared document repository.

5. The method of claim 4, wherein the document is a word processing document file, a presentation file, or a spreadsheet file.

6. The method of claim 4, wherein the document is an image file or portable document format file.

7. The method of claim 1, wherein the metadata of author is automatically populated with a user identifier corresponding to a user of the cloud storage provider from which the request to publish is received.

8. The method of claim 1, further comprising:
receiving a request to publish a second document through a productivity application interface; and
in response to the request to publish the second document, communicating a copy of the second document and second metadata comprising at least an author of the second document to the publish service.

9. A method of facilitating publishing to a content delivery system, comprising:
receiving a request to publish a document through a user interface to a productivity application; and
in response to the request, communicating a copy of the document and metadata comprising at least an author to a publish service.

10. The method of claim 9, wherein the copy of the document is a word processing document file, a presentation file, or a spreadsheet file.

11. The method of claim 9, wherein the copy of the document is a portable document format file.

12. The method of claim 9, wherein the copy of the document comprises a same file type as the document stored in the shared document repository.

13. The method of claim 12, wherein the document is a word processing document file, a presentation file, or a spreadsheet file.

14. The method of claim 9, further comprising:
receiving a request to publish a second document stored in a shared document repository of a cloud storage provider through a user interface to the cloud storage provider; and
in response to the request, communicating a copy of the second document and second metadata comprising at least an author of the second document to the publish service.

15. The method of claim 9, further comprising:
in response to receiving a share request through the user interface to the productivity application, sending the document to an email recipient or converting the document to a hypertext mark-up language (HTML) format document and sending the HTML format document to an online site.

16. A service system comprising:
one or more processing systems;
a storage system providing a shared document repository;
a cloud storage service that, when executed by the one or more processing systems, directs the one or more processing systems to communicate a copy of a first document stored on the storage system to a publish service in response to receiving a request to publish the first document through a user interface to the storage system; and
a productivity application service that, when executed by the one or more processing systems, directs the one or more processing systems to communicate a copy of a second document to a publish service in response to receiving a request to publish the second document through a productivity program user interface.

17. The service system of claim 16, wherein the second document is stored on the storage system.

18. The service of claim 16, wherein the copy of the first document or the copy of the second document is a word processing document file, a presentation file, or a spreadsheet file.

19. The service of claim 16, wherein the copy of the first document or the copy of the second document is an image file or portable document format file.

20. The service of claim 16, wherein the copy of the first document comprises a same file type as the first document stored on the storage system.
